(19) United States
(12) Patent Application Publication
(10) Pub. No.: US 2026/0150857 A1
(43) Pub. Date: Jun. 4, 2026

(54) CHEESE AND WHEY PRODUCTS AND METHODS FOR MAKING CHEESE AND WHEY PRODUCTS

(71) Applicant: Khalifa University of Science and Technology, Abu Dhabi (AE)

(72) Inventors: Fawzi Banat, Abu Dhabi (AE); Mustapha Mbye, Abu Dhabi (AE); Adiba Akram, Abu Dhabi (AE)

(21) Appl. No.: 19/221,816

(22) Filed: May 29, 2025

Related U.S. Application Data
(63) Continuation-in-part of application No. 19/078,611, filed on Mar. 13, 2025.
(60) Provisional application No. 63/726,860, filed on Dec. 2, 2024.

(51) Int. Cl. A23C 21/02; A23C 1/00; A23C 19/04; A23C 19/05

(52) U.S. Cl. CPC A23C 21/026; A23C 1/00; A23C 19/04; A23C 19/054; A23C 2220/10

(57) ABSTRACT

A method of producing a cheese product and/or a whey product may include UV treating a volume of milk, adding at least one additive to form a milk mixture, wherein the at least one additive comprises camel chymosin, and separating curds and liquid whey. The cheese product may be the curds or produced from the curds. The liquid whey may be fermented. P. acidilactici bacteria may be added to the liquid whey for fermentation. The fermented liquid whey may be dried to form whey protein.

### CROSS-REFERENCE TO RELATED APPLICATIONS

This application is a continuation-in-part of U.S. application Ser. No. 19/078,611 filed Mar. 13, 2025, which claims priority to U.S. provisional application 63/726,860 filed Dec. 2, 2024, the contents of each are incorporated by reference herein.

This application is related to copending, commonly owned U.S. application entitled “Yogurt and Yogurt Production” (attorney file No. 4105.128USC1).

### TECHNICAL FIELD

The subject matter disclosed herein relates to cheese and whey products and methods for making cheese and whey products.

### BACKGROUND

Camel milk has been consumed for centuries in areas where camels are native, such as the Middle East, North Africa, and some parts of Asia. For decades, pastoralists consumed only fresh camel milk as a gift for hosts. As a result, its selling was frequently frowned upon, and it was not regarded as a commodity. Furthermore, it did not undergo any processing, excluding fermentation, to extend its shelf-life under desert conditions. Camel milk is a relatively new addition to the market, nationally or internationally. A more varied range of dairy products could be marketed due to the camel milk market's growth and the increasing understanding of its exquisite composition and transformation processes. With the availability of recent research, camel milk—a significant product recognized for its purported or real “medicinal” benefits—can now advance past its marginal status. Indeed, the camel milk market is forecasted to grow by US$1.88B during 2023-2028, accelerating at a compound annual growth rate of 5.17% during the prediction period.

Camel milk is well-recognized for its exceptional composition and nutritional aspects, making it an interesting substitute for bovine milk. It has attracted attention in the global market, and the demand for camel milk products has increased due to potential health aspects. As a result, camel dairies have been established in several countries, with certain products accessibility, such as pasteurized milk, cheese, cheese and/or whey, and milk chocolates. The growing consumer interest and unique properties of camel milk make it a fascinating role market within the dairy industries. Camel milk is celebrated for its exceptional nutritional profile and superior digestibility compared to cow milk, positioning it as a premium ingredient in the dairy industry. For example, camel milk contains between 2.1 and 4.9% protein, comprising of casein (around 80% of the protein content) and whey protein (WP) (around 20% of the protein content) while bovine milk contains about 3.3% whey protein (WP). However, commercializing camel milk products, such as cheese and whey, faces challenges related to the milk's inherent compositional properties. Accordingly, camel milk is a convincing choice for individuals seeking healthy and functional foods. The lower cholesterol content in camel milk is also attractive for consumers. Thus, there is a need for improved methods for the production of cheese and whey products from camel milk.

It is known that traditional heat treatments cause chemical alterations of milk components, including denaturation of protein, loss of flavors and vitamins, nonenzymatic browning, and depression at freezing point, which might cause adverse variations in nutritional value, flavor, and color of milk. Heat processing is applied to guarantee a high safety level and shelf-life extension for dairy products. The heat treatment includes thermization (57-68° C. for 5-30 seconds), low-temperature long-time (63-66° C. for 30 min), high-temperature long-time (72° C. for 15 seconds), in-container sterilization at 110-115° C. for 10-20 min, and sterilization at ultra-high temperature (UHT) (130-140° C. for 3-5 seconds). Pasteurized and thermized milk are distributed in chilled conditions at 4-6° C., and high-temperature long-time pasteurized milk can be stored in a refrigerator for 10-14 days. UHT-treated milk may be stored at ambient temperature and can be kept for 6 months. Pasteurization inhibits psychotropic bacteria; however, heat-resistant extracellular enzymes (lipases and proteases) retain their activity throughout processing and storage, which might cause degradation of the treated product, including flavor defects and technological problems such as gelation and sedimentation.

Pasteurization is commonly employed with camel milk. However, the conditions of pasteurization applied by each holder are regularly decided without considering camel milk specificity, with the conditions being mostly based on the standards adjusted for bovine milk pasteurization. The reported conditions for camel milk pasteurization in the literature are fairly variable (60° C./30 min; 75° C./15 min; 63° C./30 min). Simultaneously, several private companies in the United Arab Emirates (UAE), Morocco, Algeria, Tunisia, Saudi Arabia, Mauritania, Kazakhstan, and Niger produce pasteurized camel milk. All of these companies apply different conditions for pasteurization. It is worth noting that regional/national/international standards for camel milk have not yet been established or have been adopted from bovine milk. In some countries, no standards are set by the authorities, or at least, it is proposed to use the same conditions applied for bovine milk pasteurization. UV irradiation has been previously utilized only on solid foods. The US Food and Drug Administration (FDA) and the US Department of Agriculture (USDA) have approved for use in liquid foods as an alternative to heat pasteurization. UV treatment has the benefits of low costs of installation, operation, maintenance, and energy usage. UV treatment also provides the benefits of preserving the textural, nutritional, and sensory attributes of the milk, not generating waste heat, producing no toxins or chemical residues, and it can be applied with other processing methodologies for synergistic or additive effects. Nevertheless, it has restrictions for use in opaque or cloudy liquids such as milk because of its low penetrating power. Also, prolonged exposure to UV might cause damage to humans (skin cancer, burns, eyes).

### SUMMARY

In one aspect, a method of producing a cheese product and/or a whey product includes UV treating a volume of milk, adding at least one additive to form a milk mixture, wherein the at least one additive comprises camel chymosin, and separating the curds and liquid whey,

In another aspect, a protein supplement includes whey powder; and a viable count of P. acidilactici bacteria, wherein the viable count is least 10⁶ CFU/g.

In yet another aspect, a cheese product includes bottle gourd seed extract and/or gum Arabic extract, wherein the cheese product is produced by: UV treating a volume of milk; adding camel chymosin to the UV treated volume of milk to produce curds and liquid whey; and separating the curds from the liquid whey, wherein the cheese product is the curds or produced from the curds.

### BRIEF DESCRIPTION OF THE DRAWINGS

FIG. 1 is a flowchart of a method to manufacture cheese and/or whey from milk, according to some embodiments.

FIG. 2 is a schematic diagram of a system for antimicrobial treatment of camel milk using ultraviolet light according to some embodiments.

FIG. 3 is a flowchart of a method for antimicrobial treatment of camel milk using ultraviolet light according to some embodiments.

FIG. 4 is a schematic diagram of a system for antimicrobial treatment of camel milk using ultrasonic vibrations according to some embodiments.

FIG. 5 is a flowchart of a method for antimicrobial treatment of camel milk using ultrasonic vibrations according to some embodiments.

FIG. 6 is a graph 600 illustrating the cheese yield of heat-treated camel milk (CM) cheese and UV-treated camel milk (CM) cheese.

FIG. 7 is a graph 700 illustrating results of sensory evaluations (appearance, flavor, texture, overall acceptability) of heat-treated camel milk (CM) cheese and UV-treated camel milk (CM) cheese conducted using a 5-point hedonic scale. The scale ranges from 1 (dislike extremely) to 5 1. (like extremely), with intermediate scores of 2 (dislike slightly), 3 (acceptable), 4 (like slightly), and 5 (like extremely).

FIGS. 8A and 8B are graphs 800, 810 illustrating results of rheology sweeps of heat-treated camel milk (CM) cheese and UV-treated cheese with graph 800 illustrating curves for the storage modulus of heat-treated CM cheese, curve 802, and UV-treated cheese, curve 804, and graph 810 illustrating curves for the loss modulus of heat-treated CM cheese, curve 812, and UV-treated cheese, curve 814.

FIG. 9 is a graph 900 illustrating results of sensory evaluations (appearance, flavor, texture, overall acceptability) of probiotic-fortified camel milk (CM) and bovine (cow) whey powder. The scale ranges from 1 (dislike extremely) to 5 (like extremely), with intermediate scores of 2 (dislike slightly), 3 (acceptable), and 4 (like slightly).

FIG. 10 is a graph 1000 illustrating results of the ability of different strains of lactic acid bacteria, isolated from a fermented herbal medicine product, to tolerate/survive acid, pepsin and Bile & Pancreatin. Values are expressed as the mean t standard deviation (n=3).

FIGS. 11A and 11B respectively illustrate a SDS gel image 1102 and a graph 1104 illustrating changes in the expression pattern of fat genes of worms exposed different diets. The image 1102 and graph 1104 illustrate that the worms' gene expression differed when exposed different diets: OP50 (control); MNL2+Glucose; OP50+Glucose. Values are expressed in mean±standard deviation (n=3). Different superscripts (a, b, c, d) represent significantly different values (p<0.05).

### DETAILED DESCRIPTION

The present disclosure describes cheese and whey products and methods for the production of cheese and whey products. Different types of milk that may be utilized with the methods disclosed herein include bovine (cow), sheep, goat, pig, mouse, water buffalo, camel, yak, horse, donkey, llama, or human milk. People who are sensitive or have allergies to bovine milk are particularly interested in cheese and whey products made from non-bovine milk. Because it is more challenging to produce cheese and/or whey products from camel milk compared to other types of milk, the discussion of the methods disclosed herein focus on utilizing camel milk but other types of milk may be utilized to produce cheese and/or whey products from the methods disclosed herein. For example, the inventors found that that they could not produce cheese with properties acceptable to the consumer (appearance, texture, flavor, and storage) using the methods developed to make cheese from bovine milk (temperature, ingredients). The differences in composition of non-bovine milk and bovine milk affect the production of cheese and whey products and/or the properties of cheese and whey products produced from non-bovine milk. For example, camel milk has larger micelle sizes; a low κ-casein-to-β-casein ratio; a diverse array of whey proteins; and higher proteolytic activity. The κ-casein-to-β-casein ratio is 0.05 for camel milk versus 0.33 for bovine milk. The methods disclosed herein for cheese production address challenges encountered in the production of high-quality fortified cheese that has enhanced sensory, textural, and functional properties compared to existing formulations. For example, the methods described herein produce cheese with properties similar to bovine milk cheese (e.g., appearance, texture, flavor, and storage) to which consumers are accustomed. The cheese and whey products disclosed herein also contain supplements such as prebiotics and probiotics. Prebiotics utilized in the disclosed methods herein include bottle gourd seed extract, artichoke extract, fenugreek extract, and/or gum Arabic extract. A probiotic utilized in the disclosed method for the production of whey products may be Pediococcus acidilactici bacteria. The P. acidilactici bacteria may have lipid-lowering and cholesterol reducing properties, which may make the whey products beneficial for obesity management. The P. acidilactici bacteria also exhibit a high survival rate in simulated gastrointestinal conditions (low pH, pepsin, bile salts and pancreatin for an exposure duration of 2-3 hours). The P. acidilactici bacteria may also enhance shelf life of whey products because it may inhibit the growth of pathobiological bacteria. The bacteria may be P. acidilactici MNL2.

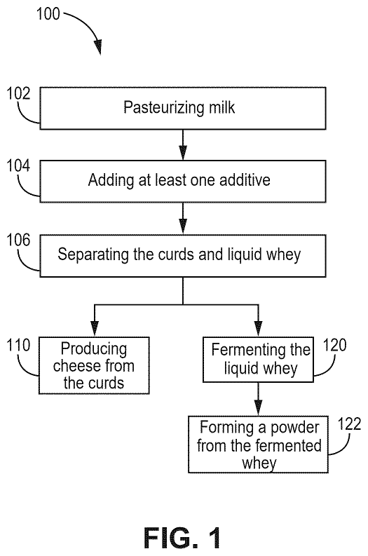

FIG. 1 is a flowchart of a method 100 to produce cheese and/or whey products from milk. The milk may be bovine (cow), sheep, goat, pig, mouse, water buffalo, camel, yak, horse, donkey, llama, or human milk. Briefly, the method 100 includes pasteurizing a volume of milk at Step 102, adding at least one additive to form a milk mixture at Step 104, and separating the curds and liquid whey at Step 106. Any suitable method may be utilized to separate the curds and liquid whey at Step 106. The curds and/or liquid whey obtained at Step 106 may be further processed. For example, in some embodiments, the method 100 further includes producing cheese from the curds obtained at Step 106, at Step 110 as discussed below in greater detail. In other embodiments, the method 100 further includes steps to produce fermented liquid whey or whey powder from the liquid whey obtained at Step 106, as discussed below in greater detail. For example, the method 100 may further include fermenting the liquid whey at Step 120 to produce fermented liquid whey. The method 100 may further include forming powdered whey from the fermented liquid whey at Step 122.

The at least one additive added to the pasteurized milk at Step 104 may include at least one coagulant, at least one prebiotic, and/or at least one enzyme. As discussed below in greater detail, the at least one additive added at Step 104 for cheese production may differ from the at least one additive added for whey production. Examples of additives that may be utilized include camel chymosin (a coagulant), and plant-based supplements such as bottle gourd seed extract, fenugreek extract, and/or gum Arabic extract. These plant-based supplements may also enhance coagulation of the milk during cheese and/or whey production. Cheese and/or whey products with these plant-based supplements may also have antimicrobial properties. The additive camel chymosin is an aspartic pepsidase that may enhance coagulation by cleaving the 105-Met106 bond of the milk protein κ-casein, thereby releasing its predominantly negatively charged C-terminus. Thus, camel chymosin may promote the separation of the milk mixture into curds and whey at Step 106 which may improve the amount of curds produced and/or the amount of whey produced. Another benefit of utilizing camel chymosin is that non-thermal pasteurization methods may be utilized for Step 102. In at least one embodiment, camel chymosin is added at Step 104 of method 100 for the production of cheese products and for the production of whey products.

### Step 102 of Method 100—Pasteurizing a Volume of Milk

Pasteurizing a volume of milk at Step 102 may reduce microbial load in the volume of milk. Thus, Step 102 may be described as an antimicrobial treatment. Types of pasteurization that may be utilized in Step 102 include ultraviolet (UV) light, ultrasonic pasteurization, cold plasma pasteurization, or thermal pasteurization. The method (e.g., temperatures, times) of pasteurizing milk for cheese and/or whey production may differ from pasteurizing milk for drinking. In at least one embodiment, UV pasteurization is utilized for Step 102 of method 100. As discussed below in greater detail, UV sterilization has been found to eliminate pathogenic microorganisms while preserving a greater quantity of essential bioactive components compared to heat treatments. For example, UV light may not damage proteins in the milk. UV pasteurization may also improve coagulation of the milk compared to ultrasonic or cold plasma pasteurization. For cheese production with non-bovine milk, this may be significant as non-bovine milk may have unique challenges in achieving efficient curd formation due to the composition of the milk. For example, UV treatment of camel milk maintains the integrity of beneficial proteins while enhancing camel milk's coagulation properties. Enhanced coagulation may promote the separation of the milk mixture into curds and whey at Step 106.

### UV Light Pasteurization

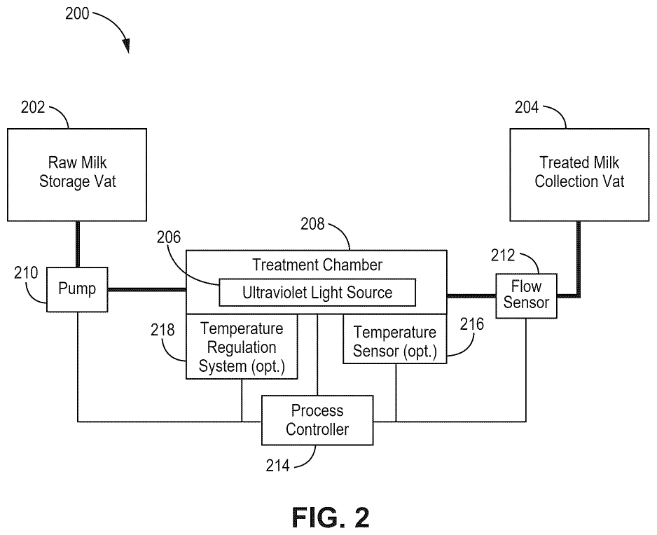

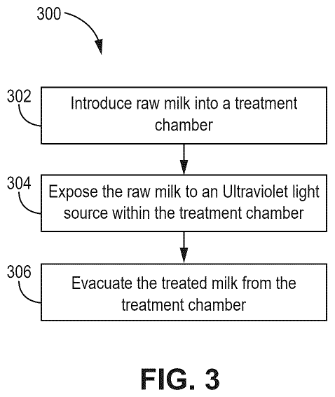

FIGS. 2 and 3 respectively illustrate a system 200 and a flowchart of a method 300 for UV light pasteurization, for example using the system 200, according to some embodiments. Turning to FIG. 2, the system 200 includes a first vat 202 for the storage of raw, untreated camel milk and a second vat 204 for the collection of treated milk after exposure to ultraviolet light generated by an ultraviolet light source 206 within a treatment chamber 208. The milk is moved from the first vat 202, through the treatment chamber 208, and into the second vat 204 by a pump 210 or other fluid movement device. In an alternative embodiment, the milk may be moved from the first vat 202, through the treatment chamber 208, and into the second vat 204 by a gravity induced flow. A flow rate of the pump 210 is preferably monitored by a flow sensor 212 and controlled by a process controller 214 to ensure adequate and consistent exposure of the camel milk to the ultraviolet light generated by the ultraviolet light source 206 within the treatment chamber 208. The flow rate of the pump 210 is preferably set so that the raw camel milk is exposed to the ultraviolet light source 206 within the treatment chamber 208 for at least 1.68 to 1.92 minutes.

The ultraviolet light source 206 provides ultraviolet light in the UV-C band having a wavelength in the range of 200-280 nanometers (nm). The ultraviolet light source 206 has a peak emission energy at about 254 nm. The ultraviolet light source 206 preferably has an intensity in the range of 4.1 to 5.5 milliwatts per square centimeter within the treatment chamber 208.

The system 200 may optionally include a temperature sensor 216 and a temperature regulation system 218, e.g. a refrigeration unit, interfacing with the process controller 214 to maintain a desired temperature of the various components of the system 200.

FIG. 3 is a flow chart of a method 300 for ultraviolet antimicrobial treatment of camel milk, for example using the system 200. This method 300 includes step 302 in which raw camel milk is withdrawn from a first vat 202 in which raw camel milk is stored and introducing the raw camel milk into a treatment chamber 208. The method 300 also includes step 304 in which the raw camel milk is exposed to an ultraviolet light source 206 within the treatment chamber 208. The method 300 further includes step 306 in which treated camel milk is evacuated from the treatment chamber 208 and collected in a second vat 204.

In the method 300, raw camel milk is continually introduced into the treatment chamber 208 and treated camel milk may be continually evacuated from the treatment chamber 208 due to the action of the pump 210. Introduction of camel milk into the treatment chamber 208 and evacuation of camel milk from the treatment chamber 208 is preferably performed at a constant flow rate in order to obtain consistent treatment of the raw camel milk. This constant flow rate may be obtained by monitoring the flow into or out of the treatment chamber 208 using a flow sensor 212 while controlling the flow through the pump 210 using a process controller 214 communicating with the flow sensor 212. The flow rate of the pump is preferably set so that the raw camel milk is exposed to the ultraviolet light source 206 within the treatment chamber 208 for at least 1.68 to 1.92 minutes. In another embodiment, the milk may be exposed for about 1.5 to about 3 minutes, about 1 to 4 minutes, about 1.7 to about 1.8 minutes, or about 1.6 to about 2 minutes.

The method 300 may optionally include regulating the temperature of the system 200 using a temperature sensor and a temperature regulation system, e.g., a refrigeration unit, interfacing with the process controller to maintain a desired temperature of the various components of the system 200. The method 300 is preferably conducted at a temperature of about 20° C. In another embodiment, the temperature may be in the range of about 15-25° C.

UV pasteurization of milk for drinking as discussed above may differ from UV pasteurization of milk for the production of cheese and/or whey. For example, the production of cheese and/or whey includes microbial, enzymatic, and physiochemical aspects not relevant to drinking milk. For example, although the raw-like flavor may be preserved and nutrients may be preserved by UV pasteurization, UV pasteurization may also have an oxidative effect on proteins and vitamins, especially B2, that may affect the texture, acidification, and/or nutrition of cheese and/or whey. As another example, residual UV exposure after inoculation could harm the bacteria added for fermenting the liquid whey at Step 120. Additionally, as discussed below in greater detail, UV pasteurized cheese was found to have enhanced rheological properties which may be attributed to the integrity of its protein network, specifically the higher presence of intact caseins. For these reasons, UV pasteurization of milk for cheese and/or whey production may be performed at a slightly lower temperature, a reduced exposure time, and lower UV intensity to maintain the desired fermentability and curd-forming properties while reducing pathogenic microbes. An exemplary method for ultraviolet antimicrobial treatment that may be utilized for Step 102 includes exposing the volume of milk to ultraviolet light at a pasteurization temperature for a pasteurization time period. The pasteurization temperature may be 10° C.-15° C., about 16° C.-18° C., about 20° C., or at most 22° C. The pasteurization time period may be about 1 to about 1.8 minutes, about 1 to 4 minutes, about 1.6 to about 1.7 minutes, about 1.3 to about 2 minutes, at least 1.6 minutes, or at least 1.9 minutes. The wavelength of the UV light may be in the range of 190-260 nanometers (nm) (UVC light). The UV light source may have a peak emission energy at about 244 nm. The UV light source may have an intensity in the range of 3.8 to 5.1 milliwatts per square centimeter.

### Ultrasonic Pasteurization

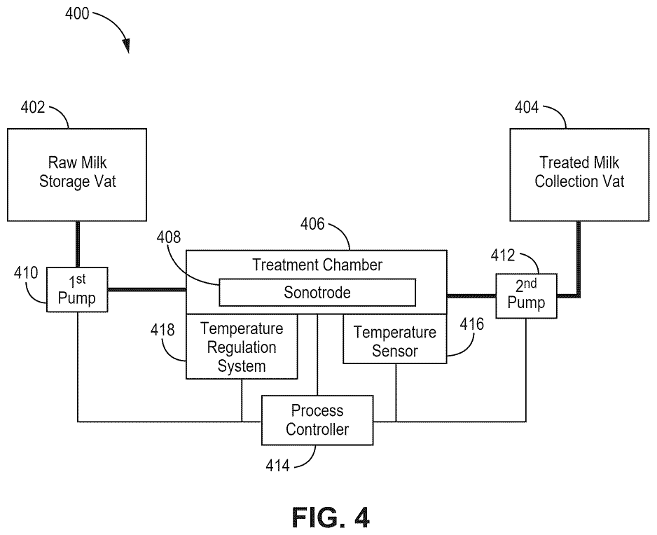

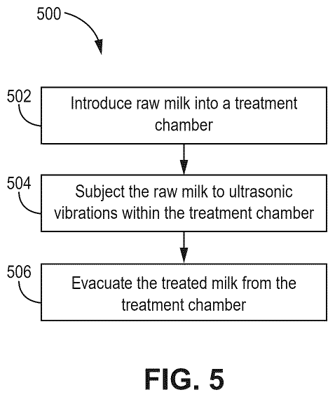

FIGS. 4 and 5 respectively illustrate a system 400 and a flowchart of a method 500 for ultrasonic antimicrobial treatment of camel milk, for example using the system 400 according to some embodiments. Turning to FIG. 4, the system 400 includes a first vat 402 for the storage of raw, untreated camel milk and a second vat 404 for the collection of treated milk after subjecting the raw camel milk to ultrasonic vibration within a treatment chamber 406 using a sonotrode 408. The milk is moved from the first vat 402 to the treatment chamber 406, and into the second vat 404 by a first pump 410 or other fluid movement device. Following treatment, the milk is moved from the treatment chamber 406 to the second vat 404 by a second pump 412. Operation of the first and second pumps 410, 412 is preferably controlled by a process controller 414 to ensure adequate and consistent exposure of the camel milk to the ultrasonic vibrations generated by the sonotrode 408 within the treatment chamber 406. The raw camel milk is exposed to the ultrasonic vibrations within the treatment chamber 406 for about 10 minutes. In another embodiment, the time may be about 5 minutes to about 15 minutes. In an alternative embodiment, the milk may be moved from the first vat 402 to the treatment chamber 406 and from the treatment chamber 406 into the second vat 404 by a gravity induced flow where the first and second pumps 410, 412 are replaced by valves.

The ultrasonic vibrations preferably have a frequency of about 20 kHz (within typical tolerances) and a power of about 750 watts.

The system 400 includes a temperature sensor 416 and a temperature regulation system 418, e.g. a refrigeration unit, interfacing with the process controller to maintain a desired temperature of the treatment chamber 406 due to heat generated in the camel milk by the ultrasonic vibrations generating localized heat due to cavitation effects, when microscopic bubbles formed by the ultrasonic vibrations collapse and release energy, leading to a rise in temperature of the camel milk being treated in the treatment chamber 406.

FIG. 4 is a flow chart of a method 500 for ultrasonic antimicrobial treatment of camel milk, for example using the system 400. This method 500 includes step 502 in which raw camel milk is withdrawn from a first vat 402 in which raw camel milk is stored and the raw camel milk is introduced into a treatment chamber 406. The method 500 also includes step 504 in which the raw camel milk is subjected to ultrasonic vibrations within the treatment chamber 406 generated by a sonotrode 408. The method 500 further includes step 506 in which treated camel milk is evacuated from the treatment chamber 406 and collected in a second vat 404.

In the method 500, the camel milk is preferably treated in a batch process rather than a continuous process. The treatment chamber 406 is filled with raw camel milk from the first vat 402 and then treated by subjecting the milk to ultrasonic vibrations. The treated milk is then drained from the treatment chamber 406 to the second vat. Introduction of camel milk into the treatment chamber 406 and evacuation of camel milk from the treatment chamber 406 is preferably performed at a constant flow rate in order to obtain consistent treatment of the raw camel milk. The raw camel milk is subjected to the ultrasonic vibrations within the treatment chamber 406 for about 10 minutes. In another embodiment, the time may be between about 5 and about 15 minutes.

The sonotrode, configured to provide ultrasonic vibrations, operates at a frequency of 20 kHz and provides a power of about 750 watts. The ultrasonic vibrations may be applied in a pulsed mode with a 50% duty cycle for a period of at least 10 minutes. Each duty cycle may last 20 seconds and includes 10 seconds of applying the ultrasonic vibrations followed by 10 seconds of not applying the ultrasonic vibrations.

The method 500 may include regulating the temperature of the treatment chamber 406 using a temperature sensor 416 and a temperature regulation system 418, e.g., a refrigeration unit, interfacing with the process controller 414 to maintain a desired temperature within the treatment chamber 406. The method 500 is preferably conducted at a temperature of about 20° C.

As discussed above, the production of cheese and/or whey includes microbial, enzymatic, and physiochemical aspects not relevant to the production of drinking milk. Therefore, compared to ultrasonic pasteurization of milk for drinking, ultrasonic pasteurization of milk for cheese and/or whey production may be performed at a slightly lower temperature, a reduced pasteurization time period, and reduced power level to maintain the desired fermentability and curd-forming properties while reducing pathogenic microbes. An exemplary method for ultrasonic antimicrobial treatment that may be utilized for Step 102 includes exposing the volume of milk to ultrasonic energy at a first temperature for a first time period. The ultrasonic energy may be characterized by a frequency and/or by power. The frequency may be about 20 kHz (within typical tolerances). The power may be about 740 watts, at most 740 watts. The ultrasonic energy may be applied in a pulsed mode. The pulsed mode may be a 50% duty cycle. Each duty cycle may last 20 seconds and includes 10 seconds of applying the ultrasonic vibrations followed by 10 seconds of not applying the ultrasonic vibrations. The first time period may be about 10 minutes or at least 10 minutes. The first temperature may be about 10° C.-20° C., about 15° C.-18° C., about 20° C., or at most 22° C.

### Step 104 of Method 100—Adding at Least One Additive to Form a Milk Mixture

The coagulants that may be utilized for cheese and whey production include bottle gourd seed extract and/or fenugreek extract. Bottle gourd seed extract may also be a prebiotic. Gum Arabic extract is another prebiotic that may be utilized. The at least one enzyme may be camel chymosin, an aspartic pepsidase. The camel chymosin may enhance coagulation by cleaving the Phe105-Met106 bond of the milk protein κ-casein, thereby releasing its predominantly negatively charged C-terminus. Thus, camel chymosin may promote the separation of the milk mixture into curds and whey. In addition to camel milk, camel chymosin may be utilized for cheese and/or whey production from other types of milk.

The concentration of camel chymosin may be 0.01%-0.05%, of the milk mixture, which corresponds to 100 to 500 μL per liter of milk. In one embodiment, 1% v/v/bottle gourd seed extract per 100 mL of pasteurized milk and 5% camel chymosin per 100 mL of pasteurized milk are added to the pasteurized milk. In another embodiment, 1% v/v artichoke extract per 100 mL of pasteurized milk, 1% v/v/bottle gourd extract per 100 mL of pasteurized milk; and 5% camel chymosin per 100 mL of pasteurized milk are added to the pasteurized milk. The concentration of bottle gourd seed extract and/or artichoke extract may be about 1% v/v per 100 mL of pasteurized milk, at least 1% v/v per 100 mL of pasteurized milk, or about 1%-2% v/v per 100 mL of pasteurized milk.

Camel chymosin may produce a softer cheese with high moisture because camel chymosin may promote efficient milk coagulation. However, high moisture may not be ideal. Bottle gourd seed extract, a prebiotic rich in proteolytic enzymes and bioactive compounds, may complement the camel chymosin coagulation process by enhancing curd formation and improving the structural integrity of the cheese. Gum Arabic extract, a natural prebiotic fiber, may be utilized to fortify the cheese's functional and health properties, promoting gut health by supporting beneficial bacteria and aiding digestion. These three components may synergistically optimize cheese texture, yield, nutritional value, and improve the shelf life.

In at least one embodiment, the at least one additive added at Step 104 is camel chymosin and additional additives are added either during cheese production or whey production. For example, bottle gourd seed extract and gum Arabic extract may be added during cheese production (e.g., Step 110). As another example, additional additives may be added at Step 120 of whey production.

### Cheese Production

In embodiments where camel chymosin, bottle gourd seed extract, and gum Arabic extract are added at Step 104, the curds obtained at Step 110 may be utilized as the cheese product or further processed into a cheese product. In other embodiments, the bottle gourd seed extract and gum Arabic extract are not added at Step 104, but instead are added to the curds at Step 110. The fortified curds may be further processed, for example by cutting, heating, pressing, and/or brining. The concentration of bottle gourd seed extract and/or artichoke extract added at Step 110 may be about 1% v/v per 100 g of curds, at least 1% v/v per 100 g of curds, or about 1%-2% v/v per 100 g of curds.

In some embodiments, the cheese product produced with method 100 retains bioactive compounds associated with antioxidant and anti-diabetic properties. For cheese produced from camel milk, these three components, camel chymosin, bottle gourd seed extract, and gum Arabic extract, address the technical challenges of camel milk coagulation and enhance the final product's overall health benefits. In at least one embodiment, a cheese product produced by method 100 comprises bottle gourd seed extract and/or gum Arabic extract.

### Whey Product Production

In some embodiments, producing liquid whey comprises adding camel chymosin, bottle gourd seed extract, and gum Arabic extract at step 104. After Step 106, the liquid whey may be refrigerated. For example, the liquid whey may be stored at about 4° C.

As noted above, method 100 includes additional steps to produce fermented liquid whey and/or whey powder. For example, the liquid whey obtained at Step 106 may be processed in Step 120 to produce fermented liquid whey and the fermented liquid whey may be further processed at Step 122 to produce whey powder.

At Step 120, the liquid whey obtained from Step 106 is fermented to produce fermented liquid whey. In some embodiments, Step 120 includes adding additional additives, such as the bottle gourd seed extract and/or the gum Arabic extract, to the liquid whey. In at least one embodiment, Step 120 includes warming the liquid whey to a first temperature, adding P. acidilactici bacteria to the milk mixture, and fermenting the whey fermentation mixture at the fermentation temperature for a fermentation time period. As discussed above, the temperature of the liquid whey at the beginning of Step 120 may be about 4° C. In some embodiments, the cooled liquid whey may be warmed to the first temperature at a rate of about 1° C.-2° C. per minute. In other embodiments, the liquid whey may be warmed to the first temperature over a period of about 20-30 minutes. In some embodiments, the first temperature and the fermentation temperature are the same. The first temperature and/or the fermentation temperature may be 34° C.-42° C., about 38° C., or at most 38° C. The fermentation time period may be 6-10 hours, 8-10 hours, or at least 8 hours. In one non-limiting example, the fermentation temperature is 38° C. and the fermentation time period is 8 hours. Step 120 may include fermenting the liquid whey until the fermentation mixture reaches a pH of: approximately 4.3-4.5, approximately 4.5, or at most 4.5.

The P. acidilactici may comprise 3% of the whey fermentation mixture. A strain of P. acidilactici suitable for whey production as disclosed herein may be characterized by one or more of the following: a survival rate of at least 10⁶ CFU/g at the time of consumption (the generally accepted minimum viable count for probiotic efficacy), ability to survive in pH≤2.5, in pepsin, in bile salts and pancreatin, exhibit bile salt hydrolase (BSH) activity, exhibit cholesterol assimilation (thereby reducing the amount of cholesterol that may be absorbed by the host), antibiotic resistance to one or more antibiotics, or be non-hemolytic. The survival rate at the time of consumption may be at least 10⁶ CFU/g. The survival rate in pH≤2.5 may be approximately 86%-96%, at least 86%, at least 90%, at least 94%, at least 96%, or approximately 96%. The survival rate in pepsin may be approximately 66%-76%, at least 66%, at least 70%, at least 74%, at least 76%, or approximately 76%. The survival rate in bile salts and pancreatin may be approximately 65%-75%, at least 65%, at least 69%, at least 73%, or approximately 75%. The bile salt hydrolase (BSH) activity may be characterized by a precipitation zone of approximately 15 mm-17 mm, at least 15 mm, at least 17 mm, or approximately 17 mm. The exposure duration to evaluate the survival rate for low pH, pepsin, and/or bile salts and pancreatin may be 2-3 hours. The cholesterol assimilation may be approximately 80%-89%, at least 80%, at least 85%, at least 89%, or approximately 89%. The antibiotic resistance may include resistance to one or more of ampicillin, streptomycin, penicillin, tetracycline, kanamycin, erythromycin, gentamicin, clindamycin, and chloramphenicol. In at least one embodiment, the P. acidilactici strain is P. acidilactici MNL2. P. acidilactici MNL2 was found to be non-hemolytic and to exhibit the following characteristics: a survival rate of at least 10⁶ CFU/g, a survival rate in pH≤2.5 of approximately 96%, a survival rate in pepsin of approximately 76%, a survival rate in bile salts and pancreatin of approximately 75%, bile salt hydrolase (BSH) activity measured by a precipitation zone of approximately 17 mm, cholesterol assimilation of approximately 89%, and antibiotic resistance to ampicillin, streptomycin, penicillin, tetracycline, kanamycin, erythromycin, gentamicin, clindamycin, and chloramphenicol. Samples of P. acidilactici MNL2 were deposited on [date of the deposit with name and address of depository, accession number for the deposit].

At Step 122, the fermented whey may be converted into a whey powder. In some embodiments, Step 122 includes vacuum spray-drying the fermented whey to produce whey powder. Spray drying and freeze drying are examples of other methods that may be utilized to dry the fermented whey. A benefit of vacuum spray-drying is that the fermented whey may be dried at a lower temperature compared to the temperature utilized for spray drying. The higher temperature may reduce the nutritional content of the resulting whey powder. Additionally, vacuum spray drying takes less time and may be less expensive than freeze drying. In some embodiments, the water content of the fermented whey is reduced before vacuum spray-drying. For example, vacuum evaporation may be utilized to reduce the water content of the fermented whey.

Experimental investigation into the effect of spray drying on P. acidilactici MNL2 showed that P. acidilactici MNL2 survives the spray drying process. In these experiments, the initial viable cell counts, recorded at 10⁹ CFU/g, remained significantly high at 10⁸ CFU/g post-spray drying. Since the generally accepted minimum viable count for probiotic efficacy is 10⁶ CFU/g at the time of consumption, P. acidilactici MNL2 retained sufficient viability to ensure health benefits following the spray drying process.

The whey powder may be stored in a moisture proof container to preserve the probiotics and ensure product quality. The whey powder may be utilized as a protein supplement.

The disclosed method for whey powder production and the whey products produced may have many benefits. For example, the disclosed method may enhance manufacturing efficiency. Camel milk whey powder produced by the method disclosed herein may be utilized for obesity management. Whey powder produced by the method disclosed herein may offer superior or comparable physicochemical, technological, and functional properties to conventional cow whey protein concentrate. In some embodiments, the disclosed formulation enhances functional attributes by incorporating fermentation with P. acidilactici MNL2 and fortification with bottle gourd extract and gum Arabic as prebiotics. Whey powder with P. acidilactici MNL2 exhibits a high survival rate post-drying, lipid-lowering effects, and cholesterol-reducing capabilities, making it a valuable option for obesity management. Additionally, camel milk whey powder produced by the method disclosed herein has been found to have improved protein solubility, reduced moisture content, and appealing sensory characteristics, compared to typical camel milk whey powder.

### Experimental Assessments—Ultraviolet and Ultrasonic Pasteurization

Experiments were conducted to evaluate ultraviolet and ultrasonic treatment of camel milk, e.g., effect on microbial load, nutritional value and the longevity of the milk. The experimental results indicated that ultraviolet treatment was effective in reducing the microbial load of camel milk in one cycle (3-log reduction, 99.9%). Other treatments, including ultrasonic treatment, also achieved the standard microbial inhibition at 70% amplitude for 20 min and a power of 50% for 30 s, respectively. As shown in Table 1, heat treatment achieves a robust microbial reduction of 99.999% (typically 5-log) for most pathogens, slightly surpassing UV treatment, which provides a 99.9% reduction (typically 5-log).

TABLE 1
Comparative impact of Pasteurization vs. UV Treatment
on Microbial Pathogens in camel Milk

| | Heat-treated | | |
|---|---|---|---|
| | (72° C. for | | |
| Microbial Pathogen | 15 sec) | UV Treatment (light) | |
| Escherichia coli | 99.999% | 99.99% | (5-log reduction) |
| | (5-log reduction) | | |
| Salmonella spp. | 99.999% | 99.9% | (5-log reduction) |
| | (5-log reduction) | | |
| Listeria monocytogenes | 99.999% | 99.9% | (5-log reduction) |
| | (5-log reduction) | | |
| Staphylococcus aureus | 99.999% | 99.9% | (5-log reduction) |
| | (5-log reduction) | | |

| | | |
|---|---|---|
| Total Bacterial Count | 99.9% reduction | 99.0-99.9% reduction |

The chemical composition of camel milk was not significantly affected by UV treatment compared to thermal pasteurization, ultrasonication, and microwave. The activity of phosphatase and lactate dehydrogenase enzymes was also determined before and after processing. Additionally, the mineral profile in camel milk was evaluated before and after ultraviolet and ultrasonic treatment. The nutrients and various bioactive contents in camel milk were insignificantly affected by ultraviolet and ultrasonic as compared to thermal pasteurization. As shown in Table 2, heat treatment processing significantly diminishes bioactive components in camel milk, with reductions of 20% in lactoferrin, 17% in lysozyme, and 25% in immunoglobulin G. In contrast, UV treatment resulted in minimal reductions of 3%, 2.3%, and 2%, respectively. These findings underscore the potential of UV treatment as an effective processing method to preserve the nutritional and functional qualities of camel milk while maintaining microbial safety.

TABLE 2
Concentrations of Lactoferrin, Lysozyme, and Immunoglobulin G in
Camel Milk: Raw Milk, heat treated and UV-treated camel milk.

| | | | UV-Treated |
|---|---|---|---|
| | Raw Camel | Heat-treated | Camel |
| | Milk | Camel Milk | Milk |
| Component | (mg/L) | (mg/L) | (mg/L) |
| Lactoferrin | 180 | 140 | 175 |
| Lysozyme | 60 | 48 | 59 |
| Immunoglobulin G | 12 | 5 | 10 |

### Experimental Assessments—Cheese

Experiments were conducted to evaluate the chemical composition and pH values of heat-treated CM cheese vs UV-treated CM cheese. As shown in Table 3, cheeses made from UV-treated camel milk exhibited higher protein and fat content than heat-treated camel milk. Significant differences (P<0.05) were observed in the chemical composition between the cheese samples, except for pH. This increase may be due to the enhanced solids retention during the UV-treated cheese production. Producing cheese by method 100 reduced the moisture content, thereby concentrating the protein and fat in the final product. Heat treatments have been observed to compromise milk coagulation properties, resulting in cheeses with higher moisture content and greater loss of total solids in the whey. These findings highlight UV treatment's advantages in improving camel milk cheese's chemical composition.

TABLE 3
Chemical composition and pH values of heat-
treated CM cheese vs UV-treated CM cheese.

Cheese

| Parameter | Heat treated- CM | UV-treated CM |
|---|---|---|
| Moisture (g/100 g) | 69.8 ± 0.4a | 54.3 ± 0.3b |
| Fat (g/100 g) | 10.2 ± 1.4b | 16.9 ± 1.0a |
| Protein (g/100 g) | 13.2 ± 0.54b | 24.6 ± 1.0a |
| Ash (g/100 g) | 2.2 ± 0.1b | 4.0 ± 0.1a |
| pH | 5.2 ± 0.2a | 5.3 ± 0.3a |

a-b; Mean values in the same row with different lowercase letters differ significantly (P < 0.05). values are the mean ± SD (n = 3).

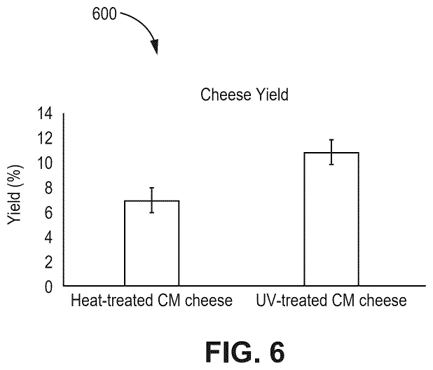

Experiments were conducted to evaluate the yield of heat-treated CM cheese and UV-treated CM cheese. As illustrated by the graph 600 provided in FIG. 6, cheeses prepared from heated treated camel milk had low yield due to poor coagulation of the camel milk because the milk coagulation properties were affected by the heat processing method, resulting in the loss of caseins and other solids in the whey. In contrast, UV-treated camel milk had good coagulation properties, resulting in a good cheese structure with a higher yield of 11% compared to 7% from heat-treated cheese.

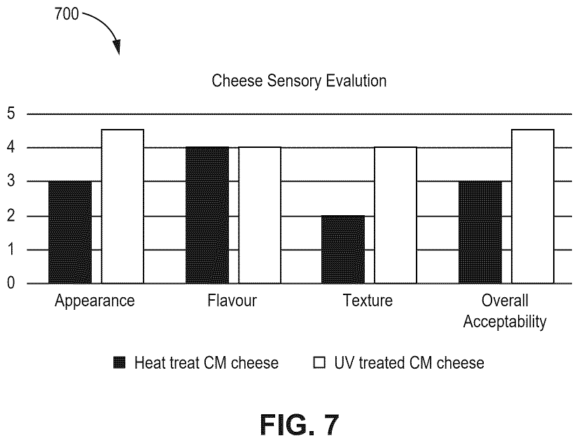

Experiments were conducted to evaluate texture parameters of heat-treated CM cheese and UV-treated CM cheese. Parameters evaluated to assess textural quality included hardness, cohesiveness, gumminess, chewiness, and resilience. The results are depicted in the graph 700 illustrated in FIG. 7. The evaluation results revealed that UV-treated CM cheese outperformed heat-treated camel cheese across all measured attributes, including appearance, flavor, texture, and overall acceptability. The higher scores achieved by UV-treated CM cheese highlight its superior quality, reflecting a well-balanced combination of desirable sensory characteristics. The preservation of natural milk components and enhanced coagulation properties in the UV treatment process contributed to producing a high-quality cheese with improved sensory appeal. The different evaluations of texture may be due in part to the hardness of UV-treated camel cheese, recorded at 476 g, being significantly higher than the hardness of the heat-treated camel cheese, recorded at 291 g. This difference is likely due to UV-treated camel cheese's faster coagulation and lower water retention. Additionally, the inclusion of 2% plant-based ingredients enhanced the texture parameters. Plant-based polysaccharides have been observed to enhance texture characteristics such as hardness, gumminess, and chewiness. These plant-based ingredients may contribute to increased structural rigidity, improving texture properties. In contrast, heat-treated camel milk cheese showed poor coagulation, resulting in a weak curd structure with higher moisture content, negatively impacting its texture attributes.

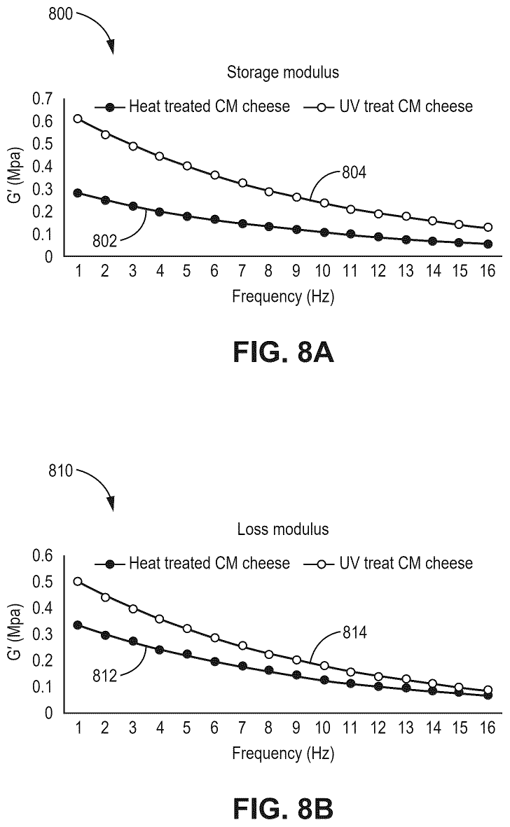

Rheological tests were conducted to assess the mechanical properties of camel milk (CM) cheese with 2% plant-based ingredients, focusing on the influence of different milk processing methods, UV-treatment and heat-treatment. These tests provided insights into the camel cheese's structural integrity and viscoelastic behavior, further informing the impact of the processing methods and ingredient incorporation on the final product. The storage modulus (G′) reflects the gel's elastic ability to recover its original state after deformation, while the loss modulus (G″) represents the energy dissipated due to viscous resistance. Frequency sweep measurements revealed significant variations in the rheological behavior of fresh cheeses depending on the processing technique applied. For example, as shown in the frequency sweep results illustrated in graphs 800 and 810 provided in FIGS. 8A and 8B, UV-treated CM cheese with 2% plant-based ingredients exhibited a higher storage modulus (G′), see curve 804, compared to heat-treated samples, see curve 802 and a higher loss modulus, see curve 814, compared to heat-treated samples, see curve 812. This indicates that UV-treated cheese has a stronger elastic behavior and a more robust interconnected network structure. The enhanced rheological properties of UV-treated cheese may be attributed to the integrity of its protein network, specifically the higher presence of intact caseins. The fortified casein network likely plays a pivotal role in improving the mechanical properties of the cheese, resulting in better structural integrity, improved quality, and enhanced texture perception during consumption. This demonstrates the potential of UV treatment combined with plant-based ingredients to produce superior camel milk cheese.

### Experimental Assessments—Whey Products

Experiments were conducted to evaluate the viability of probiotics post-drying, The survival of P. acidilactici MNL2 was assessed before and after the spray drying process. Initial viable cell counts (N) were recorded at 10⁹ CFU/g, which remained significantly high at 10⁸ CFU/g post-spray drying (No). Since the generally accepted minimum viable count for probiotic efficacy is 10⁶ CFU/g at the time of consumption, P. acidilactici MNL2 retained sufficient viability to ensure health benefits following the spray drying process. The survival rate of probiotics may be using the formula:

$$Survival rate ( \% ) = ( \frac{N}{{N}_{0}} ) \times 100$$

where N=viable cell count (CFU/g) after the drying process and N₀=viable cell count (CFU/g) before the drying process.

Experiments were conducted to evaluate the color of the fortified whey powder using a colorimeter. The powder was spread on a transparent dish, and the color space of L*, a*, and b* was measured. The experimental results are provided in Table 4. The results indicate a significant difference (P<0.05) in L*, a*, and b* values. In general, the L* value represents the lightness or darkness of a sample, where 100 denotes pure white and 0 represents pure black. The a* value reflects redness (positive) or greenness (negative), while the b* value indicates yellowness (positive) or blueness (negative). The whitish appearance of camel milk powder has been attributed to smaller fat globules and lower carotene content than cow milk. These differences likely contribute to the observed variations in color measurements between the fortified camel whey powder and the control sample.

TABLE 4
Color values of the spry-dried probiotic fortified
whey powder and cow whey powders.

| Samples | L* | a* | b* |
|---|---|---|---|
| Probiotic-fortified | 96.57 ± 0.01a | −0.18 ± 0.004a | 7.64 ± 0.045b |
| camel milk whey | | | |
| powder | | | |
| Cow whey | 89.6 ± 1.13bb | −0.61 ± 0.243bc | 8.7 ± 0.66a |
| powder | | | |

Experiments were conducted to evaluate the moisture content and water activity of the whey powder. Moisture content and water activity (aw) are two parameters for assessing the stability and safety of food products. Moisture content refers to the total amount of water in a food sample, expressed as percentage of the sample's weight (wet or dry basis). Water activity measures the water availability in food for microbial growth and chemical reactions. High moisture content and water activity levels promote microbial growth and food spoilage. Whey powders are typically produced through spray drying to achieve low moisture content, enhancing the shelf life and preventing microbial growth. Generally, moisture levels of 3-6% are targeted for whey protein concentrates. A water activity of aw≤0.6 is desirable since most spoilage microorganisms do not grow below this threshold, and pathogenic bacteria usually require a water activity of aw>0.85. The low aw of whey powders ensures microbial stability under proper storage conditions. Additionally, maintaining low aw minimizes issues such as caking, stickiness, and reduced flowability in powders. As shown by the experimental results provided in Table 5, the probiotic-fortified camel whey powder exhibited lower moisture content (5.42%) and water activity (aw=0.34), enhancing its stability and shelf life. This compares favorably to bovine whey concentrate powder obtained from the market (used as a control), which exhibited higher values.

TABLE 5
Moisture content and water activity of probiotic-
fortified CM whey powder and cow whey powder

| Sample | Moisture content (%) | Water activity (aw) |
|---|---|---|
| Probiotic fortified | 5.3 ± 0.5 | 0.34 ± 0.05 |
| camel whey | | |
| Cow whey powder | 6.2 ± 0.3 | 0.46 ± 0.023 |
| (control) | | |

Experiments were conducted to compare the solubility and the foaming capacity (FC) of camel milk whey powder samples and bovine whey powder. Protein solubility is a vital characteristic influencing key functional properties, including gelation, emulsification, and foaming. In this study, probiotic-fortified camel whey protein samples exhibited significantly higher solubility (P<0.05), reaching 91%, compared to 80% for bovine whey protein samples (Table 8). This superior solubility of camel milk powder is mainly due to its smaller fat globule size (˜1.2-1.9 μm) compared to cow milk (˜2.5-3.6 μm). The reduced particle size enhances dispersibility and hydration, making camel milk powder particularly advantageous for reconstitution and consumption. The experimental results provided in Table 6 also indicate that the camel milk whey powder has a comparable foaming capacity of 9.8% vs 9.9% for bovine whey concentrate powder. The total sample volume before and after whipping using an ultra-turra homogenizer at 13,500 rpm for 3 min was measured, and foaming capacity (%) was calculated as follows:

$$\begin{matrix}Foaming Capacity ( \% ) \\ = [ \frac{( Volume after whipping - Volume before whipping ) mL}{( Volume before whipping ) mL} ] \\ \times 100\end{matrix}$$

TABLE 6
Solubility and Foaming capacity of probiotic-fortified
CM whey powder and bovine whey powder

| Sample | Solubility % | Foaming capacity % |
|---|---|---|
| Probiotic fortified CM | 91 | 9.8 |
| Bovine whey power (control) | 80 | 9.9 |

These results underscore camel whey powder's potential as a functional ingredient in food formulations, combining high solubility and versatile performance for diverse applications.

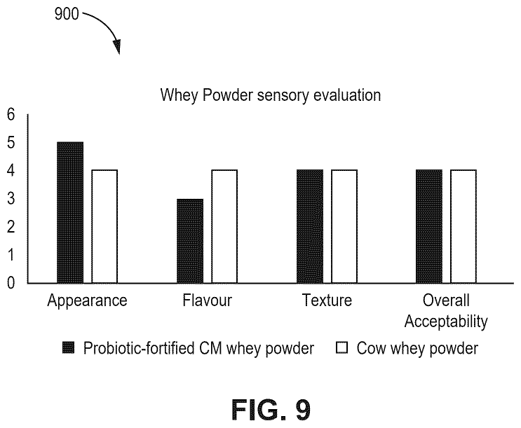

Experiments were conducted to compare the sensory characteristics of probiotic-fortified CM whey powder and bovine milk whey powder. The results are provided in graph 900 of FIG. 9. The probiotic-fortified CM whey powder achieved higher appearance scores, indicating its visual appeal. However, it scored slightly lower for taste than the bovine whey powder; both samples exhibited comparable texture profiles. Overall, both whey powders were considered acceptable, reflecting their potential for consumer satisfaction in functional food. applications.

### P. Acidilactici MNL2—Isolation and Characterization

Moola Nivarana Lehyamis a traditionally fermented herbal medicine product, obtained from India, that is primarily used for obesity reduction. Moola Nivarana Lehyam comprises a blend of dried spices, including Medhya Rasayan (nootropic herb), Terminalia chebula (3.10%), Emblica officinalis (3.10%), Terminalia bellirica (3.10%), Withania somnifera (6.85%), Zingiber officinale (3.6%), Phytophthora megasperma (3.6%), Cyperus rotundus (7%), Tamarindus indica (7%), Aloe barbadensis miller (7%), Cissus quadrangularis (7%), Amorphophallus paeoniifolius (3%), Arenga pinnata (5%), and butter (10%).

Moola Nivarana Lehyam undergoes natural fermentation at 30° C. for 72 hours. Lactic acid bacterial (LAB) species were isolated and ten LAB strains were examined for bile salt hydrolase (BSH) activity and cholesterol assimilation (Table 7). All ten strains exhibited BSH activity, and their cholesterol assimilation capacity ranged from 10.2% to 89.5%. Among them, strain MNL2 demonstrated the highest cholesterol assimilation (89.3%) and the largest BSH activity zone (17 mm of precipitation). The isolated MNL2 strain was identified through 16S rRNA gene sequencing and exhibited a 99% similarity to Pediococcus acidilactici (GenBank accession: PP346234).

TABLE 7
Assimilation of cholesterol, Hemolytic activity
and BSH of isolated LAB strains

| | | | | | Cholesterol |
|---|---|---|---|---|---|
| Isolate | Color | | Hemolytic | BSH | assimilation |
| Name | morphology | Shape | activity | activity | (%) |
| MNL 1 | White/ | cocci | NA | ++ | 25.3 |
| | Smooth | | | | |
| MNL 2 | White | cocci | NA | +++ | 89.3 |
| MNL 3 | White/ | rod | NA | − | 10.2 |
| | Round | | | | |
| MNL 4 | White/ | rod | NA | − | 11.7 |
| | Smooth/ | | | | |
| | Round | | | | |
| MNL 5 | White/ | cocci | NA | +++ | 89.5 |
| | Smooth | | | | |
| MNL 6 | White | cocci | NA | + | 32.1 |
| MNL 7 | White | rod | NA | − | 25.5 |
| MNL 8 | White | cocci | NA | + | 23.4 |
| MNL 9 | White | cocci | NA | ++ | 41.5 |
| MNL 10 | White/ | rod | NA | − | 24.5 |
| | Round | | | | |

All isolated LAB strains were tested against nine antibiotics (Table 8 and Table 9), including ampicillin, streptomycin, penicillin, tetracycline, kanamycin, erythromycin, gentamicin, clindamycin, and chloramphenicol. Most isolates were susceptible to these antibiotics. However, P. acidilactici MNL2 displayed resistance to all nine antibiotics. The evaluation followed European Food Safety Authority (EFSA) guidelines, suggesting that P. acidilactici MNL2 could potentially contribute to human health benefits when administered alongside antibiotics.

TABLE 8
Antibacterial activity of Lactic Acid Bacteria (LAB)
cell free supernatant against standard pathogens.
(Zone of inhibition measured by millimeter - mm).

| | Protein synthesis inhibiting targeting Antibiotic | | | |
|---|---|---|---|---|
| | Tetracycline | Kanamycin | Clindamycin | Erythromycin |
| Isolate Name | (30 μg · L-1) | (30 μg · L-1) | (30 μg · L-1) | (30 μg · L-1) |
| MNL 1 | 24 | NZ | 22 | NZ |
| MNL 2 | 19 | 10 | 28 | 15 |
| MNL 3 | 12 | NZ | 25 | 14 |
| MNL 4 | 12 | 10 | 10 | 10 |
| MNL 5 | NZ | NZ | 14 | NZ |
| MNL 6 | 22 | 20 | 16 | 16 |
| MNL 7 | 18 | 12 | 24 | 14 |
| MNL 8 | 26 | 18 | 14 | NZ |
| MNL 9 | NZ | 18 | 12 | NZ |
| MNL 10 | 18 | NZ | 24 | 12 |

TABLE 9
Antibacterial activity of Lactic Acid Bacteria (LAB)
cell free supernatant against standard pathogens.
(Zone of inhibition measured by millimeter - mm

| | | | | Nucleic Acid |
|---|---|---|---|---|
| | Protein synthesis inhibiting targeting | | | targeting |
| | Antibiotic | | | Antibiotics |
| Isolate | Ampicillin | Novobiocin | Penicillin | Erythromycin |
| Name | (30 μg · L-1) | (30 μg · L-1) | (30 μg · L-1) | (30 μg · L-1) |
| MNL 1 | 30 | 18 | 13 | NZ |
| MNL 2 | 20 | 18 | 30 | 15 |
| MNL 3 | 21 | 19 | 23 | 14 |
| MNL 4 | 18 | 18 | 20 | 10 |
| MNL 5 | 26 | 18 | 26 | NZ |
| MNL 6 | 28 | 12 | 12 | 16 |
| MNL 7 | 19 | 186 | 24 | 14 |
| MNL 8 | 13 | NZ | 11 | NZ |
| MNL 9 | 14 | 14 | 12 | NZ |
| MNL 10 | 24 | 20 | 13 | 12 |

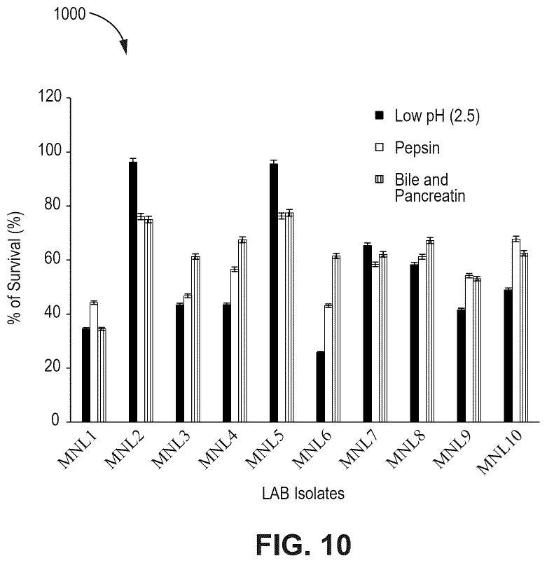

Experiments were conducted to evaluate the survival of P. acidilactici MNL2 under simulated gastrointestinal conditions that included exposure to low pH, pepsin, and/or bile salts and pancreatin for an exposure duration of 2-3.5 hours. The graph 1000 provided in FIG. 10 illustrates the results. The MNL2 strain demonstrated high tolerance, with survival rates exceeding 96.3% in low pH, 76.1% in pepsin, and 75% in bile salts and pancreatin. These findings indicate the strain's significant resistance in simulated intestinal environments, supporting its probiotic potential.

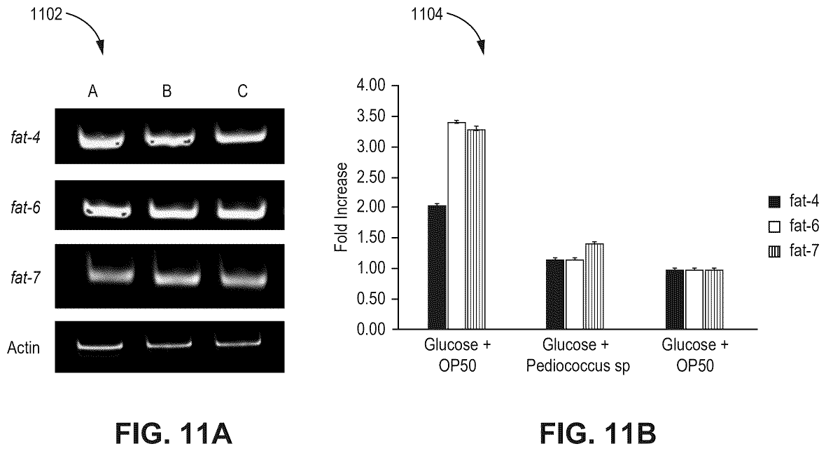

Experiments were conducted to evaluate body size alterations in Caenorhabditis elegans worms. C. elegans worms were monitored over three days under different dietary conditions. As illustrated by graph 1104 provided in FIG. 11B, worms fed an E. coli OP50+Glucose diet exhibited an increase in body size, while those on an MNL2+Glucose diet showed a reduction in size compared to the control (E. coli OP50 diet). These findings suggest that P. acidilactici MNL2 may play a role in modulating metabolic processes, potentially extending lifespan in the C. elegans N2 model. To investigate the impact of P. acidilactici MNL2 on lipid metabolism, RT-PCR analysis was conducted on the C. elegans N2 model. As illustrated by image 1102 provided in FIG. 11A, the expression of three delta-9 desaturase homologs (fat-4, fat-5, and fat-6), which encode fatty acid desaturase enzymes responsible for introducing double bonds in saturated fatty acids, was downregulated in the MNL2+Glucose-treated group. This suggests that P. acidilactici MNL2 influences lipid metabolism through a mechanism that suppresses fatty acid desaturase gene expression, leading to reduced fat accumulation.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment(s) disclosed, but that the invention will include all embodiments falling within the scope of the appended claims.

### Discussion of Possible Embodiments

The following are non-exclusive descriptions of possible embodiments of the present invention.

In some aspects, the techniques described herein relate to a method for ultraviolet antimicrobial treatment of camel milk, including introducing raw camel milk into a treatment chamber, exposing the raw camel milk to an ultraviolet light source within the treatment chamber, and evacuating treated camel milk from the treatment chamber.

The method of the preceding paragraph can optionally include, additionally and/or alternatively any, one or more of the following features/steps, configurations and/or additional components.

In some aspects of the method, the raw camel milk is continually introduced into the treatment chamber and the treated camel milk is continually evacuated from the treatment chamber.

In some aspects of the method, introduction of camel milk into the treatment chamber and evacuation of camel milk from the treatment chamber is performed at a constant flow rate.

In some aspects of the method, the ultraviolet light source provides ultraviolet light in the UV-C band having a wavelength in a range of 200-280 nanometers (nm).

In some aspects of the method, the ultraviolet light source has a peak energy emission at about 254 nm.

In some aspects of the method, the ultraviolet light source has an intensity in a range of 4.1 to 5.5 milliwatts per square centimeter.

In some aspects of the method, the flow rate allows the raw camel milk to be exposed to the ultraviolet light source for at least 1.68 to 1.92 minutes.

In some aspects of the method, a temperature of the treatment chamber is maintained in a range of 18 to 22° C.

In some aspects of the method, a temperature of the treatment chamber is maintained at 20° C.

In some aspects, the techniques described herein relate to a method for ultrasonic antimicrobial treatment of camel milk, including introducing raw camel milk into a treatment chamber, subjecting the raw camel milk to ultrasonic vibrations within the treatment chamber, and evacuating treated camel milk from the treatment chamber.

The method of the preceding paragraph can optionally include, additionally and/or alternatively any, one or more of the following features/steps, configurations and/or additional components.

In some aspects of the method, the raw camel milk is continually introduced into the treatment chamber and the treated camel milk is continually evacuated from the treatment chamber.

In some aspects of the method, introduction of camel milk into the treatment chamber and evacuation of camel milk from the treatment chamber is performed at a constant flow rate.

In some aspects of the method, the ultrasonic vibrations have a frequency of about 20 kHz.

In some aspects of the method, the raw camel milk is subjected to the ultrasonic vibrations in a pulsed mode with a 50% duty cycle for a period of at least 10 minutes.

In some aspects of the method, each duty cycle lasts 20 seconds and includes 10 seconds of applying the ultrasonic vibrations followed by 10 seconds of not the applying ultrasonic vibrations.

In some aspects of the method, the ultrasonic vibrations have a power of about 750 watts.

In some aspects of the method, the flow rate allows the raw camel milk to be subjected to the ultrasonic vibrations for about 10 minutes.

In some aspects of the method, a temperature of the treatment chamber is maintained in a range of 18 to 22° C.

In some aspects of the method, a temperature of the treatment chamber is maintained at 20° C.

1. A method of producing a cheese product and/or a whey product comprising:
UV treating a volume of milk;
adding at least one additive to form a milk mixture, wherein the at least one additive comprises camel chymosin; and
separating curds and liquid whey.

2. The method of claim 1, wherein the at least one additive further comprises bottle gourd seed extract and/or gum Arabic extract.

3. The method of claim 2, wherein the method produces a cheese product.

4. The method of claim 1, wherein to produce a cheese product from the curds, the method further comprises adding bottle gourd seed extract and/or gum Arabic extract to the curds.

5. The method of claim 1, wherein to produce the whey product, the method further comprises:
adding P. acidilactici bacteria to the liquid whey, wherein the liquid whey is at a fermentation temperature; and
fermenting the liquid whey at the fermentation temperature for a fermentation time period.

6. The method of claim 5, wherein the P. acidilactici bacteria are non-hemolytic and characterized by one or more of:
a survival rate in pH≤2.5 of approximately 86%-96%;
a survival rate in pepsin of approximately 66%-76%; or
a survival rate in bile salts and pancreatin of approximately 65%-75%.

7. The method of claim 6, wherein the P. acidilactici bacteria is further characterized by one or more of:
a bile salt hydrolase (BSH) activity characterized by a precipitation zone of approximately 15 mm-17 mm; or
a cholesterol assimilation of approximately 80%-89%.

8. The method of claim 6, wherein the P. acidilactici bacteria is further characterized by a resistance to a plurality of antibiotics selected from the group consisting of ampicillin, streptomycin, penicillin, tetracycline, kanamycin, erythromycin, gentamicin, clindamycin, and chloramphenicol.

9. The method of claim 6, wherein the P. acidilactici bacteria is P. acidilactici MNL2.

10. The method of claim 5, further comprising drying the fermented liquid whey to produce whey powder.

11. The method of claim 10, wherein drying the fermented liquid whey comprises vacuum spray-drying the fermented liquid whey to produce the whey powder.

12. The method of claim 10, further comprising reducing water content of the fermented liquid whey before drying the fermented liquid whey.

13. The method of claim 11, wherein a viable count of the P. acidilactici bacteria in the whey powder is at least 10⁶ CFU/g.

14. A protein supplement comprising:
whey powder; and
a viable count of P. acidilactici bacteria, wherein the viable count is least 10⁶ CFU/g.

15. The protein supplement of claim 14, wherein the P. acidilactici bacteria are non-hemolytic and are characterized by one or more of:
a survival rate in pH≤2.5 of approximately 86%-96%;
a survival rate in pepsin of approximately 66%-76%; or
a survival rate in bile salts and pancreatin of approximately 65%-75%.

16. The protein supplement of claim 15, wherein the P. acidilactici bacteria are further characterized by one or more of:
a bile salt hydrolase (BSH) activity characterized by a precipitation zone of approximately 15 mm-17 mm; or
a cholesterol assimilation of approximately 80%-89%.

17. The protein supplement of claim 15, wherein the P. acidilactici bacteria is further characterized by resistance to a plurality of antibiotics selected from the group consisting of ampicillin, streptomycin, penicillin, tetracycline, kanamycin, erythromycin, gentamicin, clindamycin, and chloramphenicol.

18. The protein supplement of claim 14, wherein the P. acidilactici bacteria are P. acidilactici MNL2.

19. A cheese product comprising:
bottle gourd seed extract and/or gum Arabic extract,
wherein the cheese product is produced by:
UV treating a volume of milk;
adding camel chymosin to the UV treated volume of milk to produce curds and liquid whey; and
separating the curds from the liquid whey, wherein the cheese product is the curds or produced from the curds.

20. The cheese product of claim 19, wherein the bottle gourd seed extract and/or the gum Arabic extract are added either to the UV treated milk or the curds.
